(19) United States
(12) Patent Application Publication
(10) Pub. No.: US 2016/0360433 A1
(43) Pub. Date: Dec. 8, 2016

(54) Technique for Counting Objects in a Telecommunications Network

(71) Applicant: Telefonaktiebolaget LM Ericsson (publ), Stockholm (SE)

(72) Inventor: Peter Vaderna, Budapest (HU)

(21) Appl. No.: 15/103,226

(22) PCT Filed: Dec. 12, 2013
(86) PCT No.: PCT/EP2013/076343

§ 371 Date: Jun. 9, 2016

(51) Int. Cl. H04W 24/08; G06F 17/30; H04W 8/00

(52) U.S. Cl. CPC H04W 24/08; H04W 8/005; G06F 17/30303

(57) ABSTRACT

A technique for counting distinct objects in a telecommunications network (500) including a plurality of nodes (502-506) is provided. Each of the nodes counts a subset of the distinct object. As to a method aspect of the technique, configuration parameters (700) are sent to the plurality of nodes (502-506). The configuration parameters specify a data structure for representing a number of the distinct objects. The data structure includes an array of integers for representing the number. Two or more data records according to the data structure are received from at least one of the nodes. Each of the data records represents the number of distinct objects counted by the corresponding one of the nodes. The received data records are merged in a merged data record ac cording to the data structure by comparing corresponding integers in the received data records. The merged data record represents the number of distinct objects underlying at least one of the two or more received data records.

### TECHNICAL FIELD

The disclosure generally relates to a technique for counting objects in a telecommunications network. More specifically and without limitation, methods and devices are provided for distributedly counting distinct objects in a telecommunications network that comprises a plurality of counting nodes.

### BACKGROUND

A Network Management System (NMS) is used to monitor and administer a telecommunications network, e.g., a mobile telecommunications network such as UMTS and LTE networks. With the growing amount of data traffic, the increasing number of mobile subscribers and the involving technology of wired and wireless telecommunication, more and more diagnostic data related to network load and usage behavior of the subscribers is available to network operators and used in network management for detecting and resolving errors, network planning, optimization and service assurance. However, periodically sending or continuously streaming the large amount of diagnostic data from the plurality of nodes in the network to the NMS adds to the network traffic and requires dedicated hardware resources at both the nodes and the NMS for processing and storing the diagnostic data.

In network management, data aggregation is needed to reduce the size of the stored diagnostic data and to achieve a fast response, e.g., when querying the diagnostic data for statistics and key figures. However, limiting the amount of diagnostic data only allows for a tradeoff between spatial resolution, e.g., in terms of cells of the telecommunications network, and a temporal resolution of the diagnostic data.

Conventionally, a Performance Management (PM) counter is maintained in each of the nodes over a measurement period. The network portion observed by the node and the measurement period thus define a level of aggregation. Document U.S. Pat. No. 8,442,947 B2 describes a technique for handling performance data. Several nodes in the telecommunications network issue performance data as discrete event. An event record is stored for each event. The storage space occupied by each event record is reduced depending on the age of the event. The reduction provides intermediate records between a lowest level of aggregation for recent events and a highest level of aggregation using counters for older events. While many statistical quantities are additive in the sense that they can be further aggregated based on counters, the number of distinct elements, i.e., the cardinality, is not an additive measure. Thus, the cardinality as an aggregated quantity represented by a single number in a conventional counter cannot be further aggregated.

For example, when the number of distinct subscribers attached to a cell of the telecommunications network is countered and stored as a single number for each cell and for each measurement period, it is not possible to derive the number of distinct subscribers for a longer time interval spanning over multiple measurements periods, since one of the subscriber can be present in more than one of the measurement periods. Similarly, the number of distinct subscribers attached to a cell cluster including multiple cells cannot be obtained, since one of the subscribers may be present in more than one of the cells. Since network management is often related to the behavior and experience of subscribers, it is important for the operator to have estimations for the number of distinct subscribers fulfilling a given condition. However, counting based on a single number cannot be further aggregated due to unknown overlaps in the subsets underlying the individual counters. Similar problems occur when counting other objects in the network.

One solution for deriving the number of distinct objects on a higher level of aggregation is to maintain not only the aggregated data but the underlying high-granularity data as well, In this case, the number of distinct objects can be calculated from the high-granularity data for the higher level of aggregation. However, for a longtime analysis or for statistics based on a large number of cells, it becomes infeasible to maintain all the high-granularity data. For example, an operator providing telecommunications services to millions of subscribers has to provide hardware resources for storing the detailed information. In addition storing detailed information may be undesired due to data privacy.

Another solution maintains complete lists of objects for each aggregation level. For example, not only the number of distinct subscribers is counted per measurement period in each cell, but a complete list of subscriber identities that are active in the cell during the measurement period is maintained. Then, during further aggregation, the lists of objects are merged, duplications are eliminated, e.g., by sorting the lists, and the number of distinct objects is calculated from the merged list. However, even if the network operated choses such a memory-intensive implementation maintaining all high-granularity data or the complete lists of subscribers per measurement period and cell, querying such a data structure is slow.

### SUMMARY

Accordingly, there is a need for a technique that efficiently counts distinct objects in a telecommunications network.

According to one aspect, a method of counting distinct objects in a telecommunications network including a plurality of nodes is provided. Each of the nodes counts a subset of the distinct objects. The method comprises the step of sending configuration parameters to the plurality of nodes, wherein the configuration parameters specify a data structure for representing a number of the distinct objects, wherein the data structure includes an array of integers for representing the number; the step of receiving two or more data records according to the data structure from at least one of the nodes, each of the data records representing the number of distinct objects counted by the corresponding one of the nodes; and the step of merging the received data records in a merged data record according to the data structure by comparing corresponding integers in the received data records, wherein the merged data record represents the number of distinct objects underlying at least one of the two or more received data records.

By sending the configuration parameters to the nodes configured for counting the distinct objects, the counting nodes consistently maintain and report the specified data structure in at least some implementations. Exchanging data records according to the data structure instead of high-granularity data or complete lists of distinct objects significantly reduces the network load in same or other implementations. The data structure represents the number of distinct objects, which may also be referred to as the cardinality of the objects. Different subsets of distinct objects represented by the two or more data records may have objects in common, i.e., the subsets may overlap. Such overlaps may not influence the merged data record representing the distinct objects.

The data structure may provide a unifiable representation of the number of distinct objects. A complexity of the data structure may greater than a complexity of a single number representing the cardinality. The data structure may not explicitly include the cardinality. A complexity of the data structure may be less than a complexity of a list identifying each of the distinct objects. The complexity may be measured in memory size. The size of the data structure may be proportional to a logarithm of a logarithm of a maximum number of distinct objects representable by the data structure. The size of the data structure may be proportional to the inverse square of a relative accuracy of the number of distinct objects representable by the data structure.

In at least some implementations, the data structure may allow merging the two or more data records so that the merged data record represents the total number of distinct objects without multiplicities. The merging may ignore multiplicities of objects that have been counted in more than one of the two or more data records, e.g., without identifying redundant objects and/or without eliminating such multiplicities. The received data records may be the result of a previous merger of data records. The merged data record may be subjected to one or more further mergers of data records.

The telecommunications network may have a hierarchical topology. The method may be iteratively applied in a distributed manner and/or in accordance with the hierarchy. The data records may be received from lower branches of the hierarchical topology at each of first branching nodes of the hierarchical topology. The step of merging may be performed at the first branching nodes of the hierarchical topology. The method may further comprise the step of sending the merged data record to a second branching node that is higher in the hierarchical topology than the first branching nodes.

The telecommunications network may be a cellular network. The nodes may include one or more User Equipments (UEs) and/or one or more Network Equipments (NEs). The UEs may include one or more mobile stations. The NEs may include one or more base stations. The UEs may be wirelessly connected to the NEs.

The number of distinct objects represented by any one of the data records may be computed from the corresponding one of the data records, e.g., from at least one of the received data records and the merged data record. The configuration parameters may further specify an algorithm for computing the data record. Given any one of the data records, wherein Mⱼ is the value of the j-th integer in the array including m integers, the number of distinct objects may be computed according to

$$E = {α}_{m} m {2}^{\frac{1}{m} {\sum }_{j = 1}^{m} {M}_{j}} .$$

An object may be added to any one of the data records according to the data structure by determining, for the object to be added, a position in the array of integers and an integer value (which may be collectively referred to as the determined integer). The determined integer value may be compared with the corresponding value integer in the data record at the determined position. The determined integer may depend on a hash value of the object. The configuration parameters may specify a hash function for computing the hash value. The determined position in the array including m=2^{k} integers may be determined by the k least significant bits of the hash value of the object. The determined integer value may be the position of the least significant 1-bit in the hash value of the object relative to the position of the (k+1)-th least significant bit. Alternatively, the integer may be determined based on the least significant 0-bit that follows the k least significant bits of the hash value.

Specify the data structure may include specifying a size of the data structure. The received data records and the merged data record may be equal in size. The configuration parameters may specify the range of the integers, e.g., a number of bits to be allocated for each integer in the array. The number of bits may be determined based on a logarithm of a logarithm of a maximum number of distinct objects in the telecommunications network. The configuration parameters may specify a number, m, of integers included in the array.

The representation of the number of distinct objects may be an estimation and/or approximation, e.g., a statistical approximation. The number, m, of integers included in the array may be determined by a predefined relative accuracy of the representation of the number of distinct objects in the telecommunications network. The relative accuracy may be inversely proportional to the square root of the number m of integers included in the array.

The comparison in at least one of the step of merging and the step of adding may include determining a maximum. The integer in the array of the resulting data record at the array position of the comparison may be replaced by, or defined by, the determined maximum. In the step of merging, the comparison and the replacement may be performed for each position in the array.

Each of the data records may represent its number of distinct objects with a certain resolution in time and/or in space (which may also be referred to as the granularity of the data record or a level of aggregation of the data record). Each of the two or more received data records may represent the number of distinct objects for a predefined timeframe and/or in relation to the corresponding one of the nodes from which the data record originates. The relation to the corresponding one of the nodes may be spatial and/or topological. The corresponding one of the nodes may be the node from which the received data record originates.

The distinct objects may include distinct network events. The network events may relate to distinct events of operating the corresponding one of the nodes. Alternatively or in addition, the distinct objects may include distinct subscribers. Alternatively or in addition, the distinct objects may include data packets having distinct sources and/or destinations. The received data record originating from one of the nodes may represent those data packets routed via the corresponding one of the nodes. The distinct subscribers counted by the node may be those subscribers wired or wirelessly connected to the node.

The sent configuration parameters may specify the timeframe. E.g., a measurement periodicity for consecutive timeframes may be specified. The sent configuration parameters may include a time signal for synchronizing clocks at the nodes, based on which each of the nodes determines the timeframe. Alternatively or in addition to the measurement period, the configuration parameters may specify a reporting period. The data records may be periodically received. The configuration parameters may specify categories or criteria based on which objects detected by the node are determined as being distinct (e.g., being counted as two different objects) or determined as corresponding objects belonging to one of the distinct objects.

According to another aspect, a method of counting distinct objects in a telecommunications network including a plurality of nodes is provided. Each of the nodes counts a subset of the distinct objects. The method comprises the step of receiving configuration parameters from a network controller, wherein the configuration parameters specify a data structure for representing a number of the distinct objects, wherein the data structure includes an array of integers for representing the number; the step of adding one or more objects to a data record according to the data structure by determining, for each object to be added, an integer in the array of integers and comparing the determined integer with a corresponding integer in the data record; and the step of sending the data record according to the data structure to the network controller.

At least in some implementations, the sent data record represents the number of distinct objects among the objects represented by the data record prior to the step of adding and the added one or more objects. The data record resulting from the step of adding may be independent of an order of the added objects. Adding an object that is among the objects represented by the data record prior to the step of adding may leave the data record unchanged. Multiplicities in the added objects or caused by the added objects may not increase the number of distinct objects represented by the data record after the step of adding.

A list of objects may be maintained. The step of adding may include initializing the data record according to the data structure and/or adding each of the objects in the list to the data record. The list may be deleted upon completion of the step of adding for each object in the list.

The integer may be determined based on a hash value of the object to be added. The configuration parameters may specify a hash function for computing the hash value.

The data record may be initialized and/or sent according to a measurement period. The configuration parameters may specify the measurement period.

Aforementioned method aspects may further comprise any feature or step disclosed in the context of the other aspect. Furthermore, the method aspects may be combined.

According to a further aspect, a computer program product is provided that comprises program code portions for performing any one of the methods disclosed above, when the computer program product is executed on one or more computing devices. The computer program product may be stored on a computer readable recording medium or may be provided in a network, e.g., the telecommunications network or the Internet, for download onto such a medium.

According to one hardware aspect, a device for counting distinct objects in a telecommunications network including a plurality of nodes is provided. Each of the nodes counts a subset of the distinct objects. The device comprises a sending unit adapted to send configuration parameters to the plurality of nodes, wherein the configuration parameters specify a data structure for representing a number of the distinct objects, wherein the data structure includes an array of integers for representing the number; a receiving unit adapted to receive two or more data records according to the data structure from at least one of the nodes, each of the data records representing the number of distinct objects counted by the corresponding one of the nodes; and a merging unit adapted to merge the received data records in a merged data record according to the data structure by comparing corresponding integers in the received data records, wherein the merged data record represents the number of distinct objects underlying at least one of the two or more received data records.

According to another hardware aspect, a device for counting distinct objects in a telecommunications network including a plurality of nodes is provided, Each of the nodes counts a subset of the distinct objects. The device comprises a receiving unit adapted to receive configuration parameters from a network controller, wherein the configuration parameters specify a data structure for representing a number of the distinct objects, wherein the data structure includes an array of integers for representing the number; an adding unit adapted to add one or more objects to a data record according to the data structure by determining for each object to be added an integer in the array of integers and comparing the determined integer with a corresponding integer in the data record; and a sending unit adapted to send the data record according to the data structure to the network controller.

### BRIEF DESCRIPTION OF THE DRAWINGS

In the following, the present disclosure will be described in more detail with reference to exemplary embodiments illustrated in the drawings, wherein:

FIG. 1 schematically illustrates a device for counting distinct objects in a telecommunications network according to a one hardware aspect;

FIG. 2 schematically illustrates a device for counting distinct objects in a telecommunications network according to another hardware aspect;

FIG. 3 shows a flow chart for counting distinct objects in a telecommunications network according to one method aspect;

FIG. 4 shows a flow chart for counting distinct objects in a telecommunications network according to another method aspect;

FIG. 5 schematically illustrates a telecommunications network including embodiments of the devices of FIGS. 1 and 2;

FIG. 6 shows a bar diagram illustrating a data record as an instance of a data structure processed by the methods of FIGS. 3 and 4;

FIG. 7 schematically illustrates the telecommunications network of FIG. 5 in a stage of configuration;

FIG. 8 shows a flow chart of a step of adding an object to the data structure of FIG. 6;

FIG. 9 shows a flow chart of a step of merging two data records according to the data structure of FIG. 6;

FIG. 10 shows a flow chart of a step of computing a number of distinct objects based on the data structure of FIG. 6;

FIG. 11 schematically illustrates a non-unifiable cardinality report;

FIG. 12 schematically illustrates a unifiable cardinality report including the data structure of FIG. 6; and

FIG. 13 schematically illustrates an extension of the unifiable cardinality report of FIG. 12.

### DETAILED DESCRIPTION

In the following description, for purposes of explanation and not limitation, specific details are set forth, such as specific device and system configurations and specific methods, steps and functions, in order to provide a thorough understanding of the technique presented herein. It will be appreciated that the technique may be practiced in other embodiments that depart from these specific details. While connections, nodes and networks described herein are consistent with the Global System for Mobile Communications (GSM), the Universal Mobile Telecommunications System (UMTS) and/or 3GPP Long Term Evolution (LTE), the technique is also applicable in networks using any other access technology or routing technology.

Those skilled in the art will further appreciate that the methods, steps and functions described herein may be implemented using individual hardware circuitry, using software functioning in conjunction with a programmed microprocessor or a general purpose computer, using one or more Application Specific Integrated Circuits (ASICs), one or more Digital Signal Processors (DSPs) and/or one or more Field Programmable Gate Arrays (FPGAs). It will also be appreciated that the technique disclosed herein may be embodied in a processor and a memory coupled to the processor, wherein the memory stores one or more programs that perform the methods, steps and functions described herein when executed by the processor.

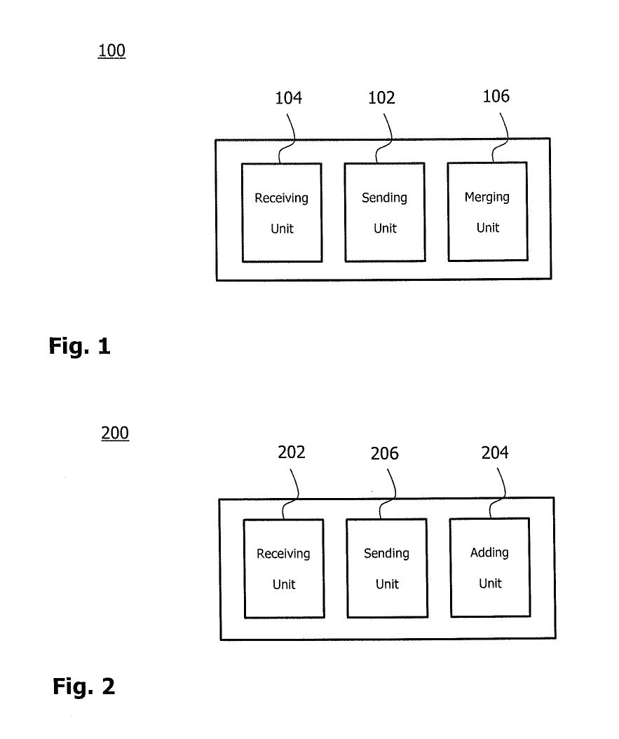

FIG. 1 schematically illustrates a device 100 for counting distinct objects in a telecomunications network including a plurality of nodes, each of which counts a subset of the distinct objects. The device 100 includes a sending unit 102 and a receiving unit 104, which are optionally combined into a single transceiving unit. The sending unit 102 and the receiving unit 104 are adapted to communicate with the counting nodes of the telecommunications network. The device 100 further comprises a merging unit 106 adapted to process data received by the receiving unit 104.

The device 100 is implemented in one or more controlling nodes (also referred to as network controllers) adapted to control the operation of the telecommunications network. The one or more controlling nodes are nodes of the telecommunications network different from the counting nodes.

FIG. 2 schematically illustrates a device 200 for counting distinct objects in a telecommunications network including a plurality of nodes, each of which counts a subset of the distinct objects. The device 200 includes a receiving unit 202 adapted to receive configuration parameters from a network controller, e.g., the device 100. The device 200 further includes an adding unit 204 operating according to the configuration parameters received by the receiving unit 202. The adding unit 204 outputs data to a sending unit 206 for sending the data towards the network controller. The receiving unit 204 and the sending unit 206 can be implemented in a single transceiving unit adapted to communicate with the network controller.

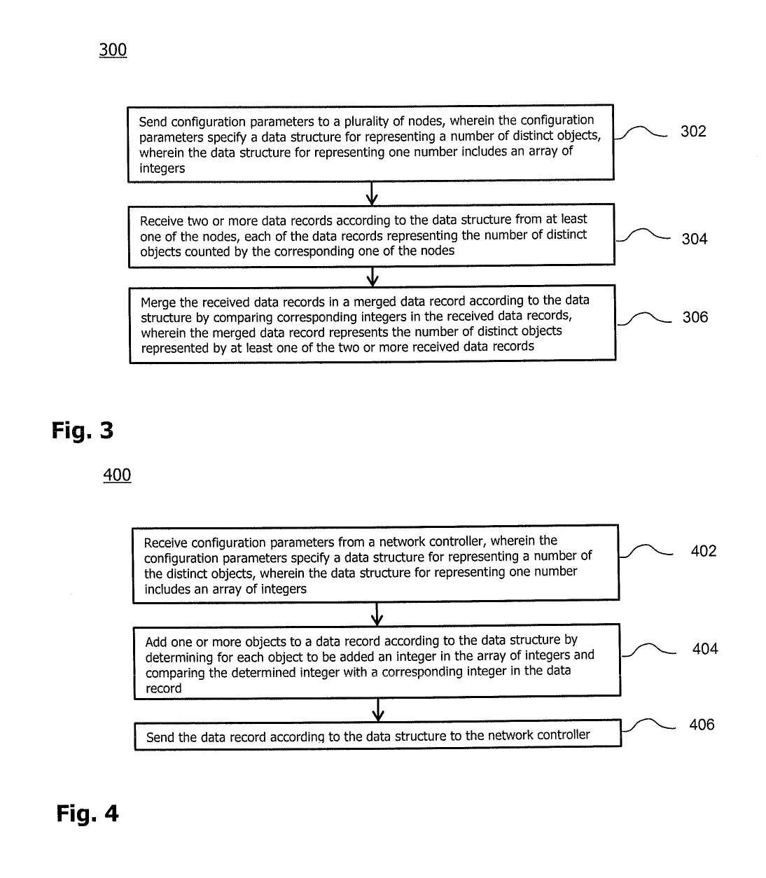

FIG. 3 shows a flow chart of a method 300 of counting distinct objects in a telecommunications network including a plurality of nodes, each of which counts a subset of the distinct objects. The method 300 can be performed by the device 100.

In a step 302 of the method 300, configuration parameters are sent to the plurality of nodes. The configuration parameters specify a data structure configured for representing a number of the distinct objects. The data structure allows representing one number, e.g., the number of distinct objects in one subset of objects. The data structure is more complex than a single number and includes an array of integers.

In a step 304 of the method 300, two or more data records according to the data structure are received from at least one of the nodes. For example, one data record may be received from each of the nodes, or a temporal sequence of data records is received from at least one of the nodes. Each of the received data records represents the number of distinct objects counted by the corresponding one of the nodes.

In a step 306 of the method 300, at least some of the received data records are merged into a single merged data record. The merged data record also fulfills the data structure. The merging does not increase the size of the data structure. The step 306 includes comparing integers at corresponding positions in the array of the received data records for determining the integer at the same position in the merged data record. The merged data record represents the number of distinct objects represented by at least one of the two or more received data records. The merged data record thus represents the number of distinct objects in a union of the subsets represented by the received data records, e.g., without the need of communicating and processing a detailed lists specifying each of the distinct objects in the subsets.

The steps 302, 304 and 306 can be performed by the units 102, 104 and 106, respectively.

FIG. 4 shows a flow chart of a method 400 of counting distinct objects in a telecommunications network including a plurality of nodes, each of which counts a subset of the distinct object. The method 400 can be implemented in any one or each of the plurality of nodes, e.g., by the device 200.

In a step 402 of the method 400, configuration parameters are received from a network controller, e.g., the device 100. The configuration parameters specify a data structure configured for representing a number of distinct objects. The data structure for representing one number, e.g., the number of distinct objects in one of the subsets or a union thereof, includes an array of two or more integers.

In a step 404 of the method 400, one or more objects are added to a data record according to the data structure. The step 404 includes determining, for each object to be added, one integer in the array of integers and comparing the determined integer with a corresponding integer in the data record. Depending on the result of the comparison, the corresponding integer in the data record is selectively replaced by the determined integer.

In a step 406 of the method 400, the data record resulting from the adding step is sent to the network controller. The sent data record represents the number of distinct objects including the one or more added objects.

The steps 402, 404 and 406 can be performed by the units 202, 204 and 206, respectively.

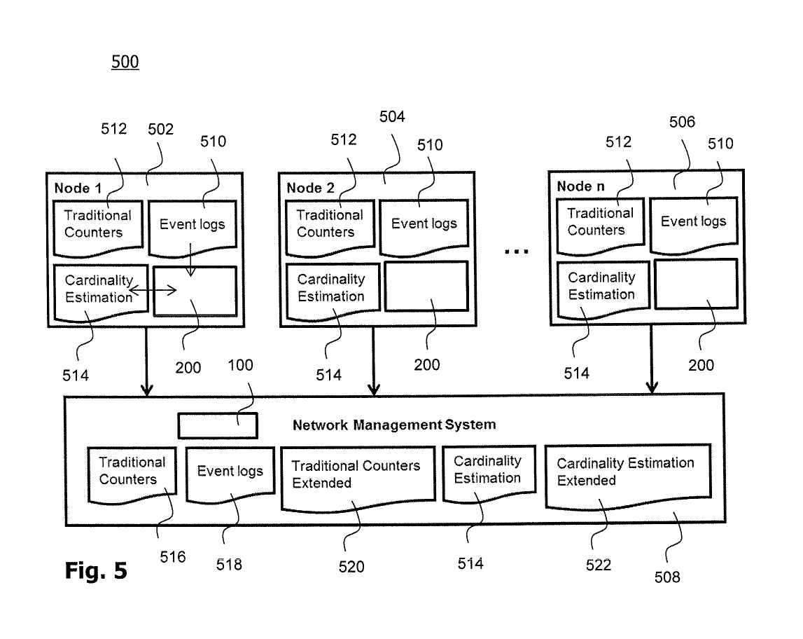

FIG. 5 schematically illustrates an exemplary telecommunications network 500 within which the technique disclosed herein can be implemented. The telecommunications network 500 includes a plurality of nodes 502, 504 and 506 adapted to locally count a subset of the distinct objects. Counting results are reported from each of the nodes 502 to 506 to a Network Management System (NMS) 508. The NMS 508 includes the device 100 performing the method 300. Each of the counting nodes 502 to 506 includes the device 200 performing the method 400.

Management of the telecommunications network 500 becomes more and more challenging as the number and heterogeneity (e.g., different Radio Access Technologies) of nodes 502 to 506 increases. For example, in a mobile telecommunications network 500 according to UMTS or LTE, the nodes 502 to 506 are Nodes B and e-Nodes B, respectively. The nodes 502 to 506 are collectively referred to as Network Equipments (NEs) and provide wireless access to currently active subscribers of the telecommunications network 500.

The NMS 508 and Operating Support Systems (OSS) provide means for network planning, configuring the NEs 502 to 506, assuring connections, executing applications in the NEs, monitoring Quality of Experience (QoE), finding and resolving errors, etc. While FIG. 5 illustrates the NEs 502 to 506 reporting to the NMS 508, the device 100 is alternatively included in the OSS or both NMS and OSS for receiving the reports from the NEs 502 to 506.

Herein, a device providing NMS and/or OSS functionalities is collectively referred to as network controller. The network controller 508 provides tools for collecting data reported from the different nodes 502 to 506. The reported data include alarms, measurements and configuration status. The network controller 508 further includes tools for intervening into the network operation. The interventions include restarting one or more of the nodes 502 to 506, setting parameters, and starting or stopping applications.

Each of the nodes 502 to 506 stores log files 510 for locally recording events underlying the data to be reported. The log files 510 record events in detail, e.g., at least one of a subscriber connecting or disconnecting to the corresponding node, UE models used for wirelessly connecting to the corresponding node, applications underlying the data traffic routed via the corresponding node, and source and/or destination Internet Protocol (IP) addresses of data packets routed via the corresponding node.

The data 510 recorded by the nodes 502 to 506 and the reports based on the recorded data 510 and collected by the NMS 508 allow monitoring the performance of the telecommunications network 500. Based on the reported data, the NMS 508 detects performance degradation. While reporting the detailed log files 510 requires significant processing resources at the nodes 502 to 506 and the NMS 508 and occupies network bandwidth, the technique presented herein allows reducing resource consumption and adds the flexibility of analyzing the reported data at different levels of aggregation.

Counting the distinct objects in the detailed log files 510, e.g., the number of distinct subscribers, which fulfill criteria prescribed in the configuration parameters, provides indicators for the network performance. One of more conventional counters 512 reprsenting the number of distinct objects by a single number are optionally included in each of the nodes 502 to 505.

As a comparative example, storing and reporting such traditional counters 512 is memory-efficient and allows the NMS 508 to localize a performance reduction and to identify a cause of performance degradation, if the criteria prescribed by the NMS 508 for defining the distinct objects fit to the actual problem. Otherwise, the NMS 508 cannot identify the reason of performance degradation at all, or the conventional counting has to be repeated by reanalysis the detailed log files 510 that have to be maintained in parallel to the conventional counters 512 and by sending a further conventional report upon request of the NMS 508.

In contrast, the NMS 508 including the device 100 can find the reason of performance degradation in a shorter amount of time and/or causing less control traffic by setting up the data structure throughout the network in a consistent manner. The device 200 selects based on the criteria predefined by the NMS 508 relevant objects from the detailed log files 510 as log file entries fulfilling the criteria. The device 200 adds the object in the step 404 to one or more data records (shown at reference sign 514) using the network-consistent data structure. The one or more data records 514 are reported to the device 100 in the NMS 508. Since each of the data records represents the number of distinct objects, the NMS 508 has the information provided by the conventional counters 512, e.g., for short-term analysis at a high level of granularity in order to localize the problem as precisely as possible.

In addition, the received data records 514 allow for a long-term analysis and/or a network-global analysis by merging two or more data records according to the step 306 in time, in space or both. The NMS 508 can thus derive statistics of the performance of the network 500 at a level of aggregation that is not restricted to the level of aggregation chosen for the reporting.

The property of the data structure used for the data records 514 for adding further objects and merging different data records thus provides different types of data used, e.g., for short-term analysis and long-term analysis by the NMS 508, without maintaining or transmitting the detailed log files 510. E.g., for the long-term analysis, aggregated data can be derived in the step 306 of merging high-granularity data represented by the reported data records 514.

The high-granularity measurement data recorded in the log files 510 are reported within the NEs 502 to 506 as they occur. The log files 510 further contain a timestamp and one or more identifiers stored in association each log file entry. The criteria for determining the distinct objects based on the log files 510 are applied to the timestamps and/or identifiers. The identifiers may include a user identifier, a cell identifier, a node identifier, or any combination thereof. Additional information stored in association with an entry in the log files 510 optionally includes event-related parameters, result codes, etc.

Alternatively to the event-driven recording of the log files 510, high-granularity measurement can be performed periodically and recorded in the log files 510 or in dedicated measurements files.

The measurements can be performed by the nodes 502 to 506 or by one or more UEs connected to the nodes. For example, Radio Environment Statistics (RES) measurements are sent from the UEs to the corresponding one of the nodes 502 to 506. Each of the measuring UEs sends the RES measurement data, one after the other, at a periodicity of few seconds.

The device 200 in the nodes 502 to 506 may also aggregate the data to be reported, e.g., by merging two or more data records prior to sending the data record resulting from the merging. For example, the device 200 adjusts the level of aggregation of the data records (to be reported to the device 100) in response to the configuration parameters received in the step 402 from the device 100. The data may thus be aggregated partially at the plurality of nodes 502 to 506 and partially at the NMS 508. Alternatively, the device 100 exclusively performs data aggregations in the step 306 of merging data records.

Aggregated data typically spans over a timeframe longer than a mean duration between events recorded in the log files 510 or the measurement periodicity. For example, the data may be aggregated in the step 306 to span over 15 minutes or more. The aggregated data further includes an indicator of the timeframe, i.e., a Reporting Output Period (ROP).

Alternatively or in addition, the step 306 of merging data records may increase the level of aggregation with respect to space or network topology. For example, the data is aggregated from a subscriber level to the level of a radio cell, a Radio Base Station (RBS), a Radio Network Controller (RNC), a RBS cluster, a region, etc. The aggregated data further includes an identifier of the aggregation level, e.g., a level in the network topology or a network element representing the level of aggregation, such as a radio cell identifier, an RBS identifier, a RNC identifier, a RBS cluster identifier, a region identifier, etc.

The aggregated data is represented by the merged data record. Examples for aggregated data include counting samples and summing-up values for averaging the values. Alternatively, the aggregated data includes a distribution represented by a histogram. The histogram includes one cardinality value for each of a multiplicity of bins. The histogram is represented by a corresponding multiplicity of data records.

Aggregated data represented according to the data structure can be further aggregated, e.g., during an analysis performed by the NMS 508. For example, if the aggregated data is the number of specific events detected by a first cell in one timeframe, the data can be further aggregated to represent the number of occurrences of the specific event in the first cell over multiple timeframes. The criteria (e.g., categories) prescribed by the NMS 508 define what distinguishes the specific events as distinct objects. E.g., an event for an invitation message and an event for a response to the invitation message can be defined as indistinguishable objects, so that the occurrences of corresponding events in different timeframes are counted as one event. Similarly, the data representing the number of occurrences of a specific event can be aggregated in space by merging the data record received from the first cell with a data record relating to the same timeframe received from a second cell that is different from the first cell. Events observed in both the first cell and the second cell can be defined as indistinguishable events, so that the merged data record represents the number of occurrences of the specific event without counting twice those events that occur in both the first cell and the second cell.

As a further example, the number of active subscribers per ROP and per NE can be further aggregated by virtue of the data structure by merging data records representing different ROPs and/or different NEs without multiple counts of a subscriber being active in more than one ROP and/or in more than one NE.

The NMs 508 receives the data record 514 according to the step 304. The NMS 508 derives the cardinality 516 based on the received data structure 514. Optionally, the NMS 508 extends the data structure 514 to include further identifiers for distinguishing data structures 514 received from the different nodes 502 to 506 and/or for identifying different measurements periods. The extended data record 522 optionally specifies a type for the objects counted using the data structure.

The NMS 508 optionally stores log files 518 received from one or more of the plurality of the counting nodes 502 to 506. For example, the log files 518 can be received from those nodes that have not yet been upgraded to provide a data records 514 according to the data structure in the step 406 of the method 400.

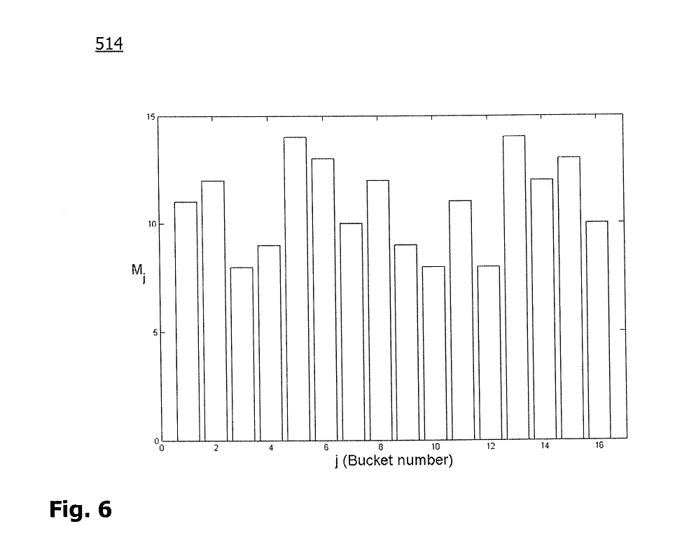

The data structure includes an array of integers. FIG. 6 shows a bar diagram illustrating a data record 514 according an exemplary implementation of the data structure. The data structure includes m=16 integers Mⱼₜ, j=1, . . . , m. The index j specifies the position of the integer within the array. The index j is also referred to as a bucket number. One data record specifies for each bucket number j=1, . . . , m one integer value Mⱼ. The data record is an instance of the data structure. Any number of data records having the same data structure can be merged in the step 306.

The data structure can be a probabilistic data structure, e.g., according to research publication “probabilistic counting algorithms for database applications”, by P. Flajolet et al., Journal of Computer and System Sciences, Vol. 31, No. 2, pp. 182 to 209, Academic Press 1985, or according to “Loglog counting of large cardinalities” by M. Durand et al., LNCS 2832, Algorithms ESA 2003, pages 605 to 617, Springer 2003. The data structure is an extension of the data structure of a Bloom filter. The size of memory required to store the data structure scales with the logarithm of the logarithm of the total number of distinct objects. This exceptional scaling property enables representing the number of up to 100 million distinct objects with 1% to 2% error using only 1.5 kilobytes of memory. The representation using a probabilistic data structure is an estimation, where-in the error scales proportional to the inverse square route of m. Since the number of distinct objects is also referred to as the cardinality, representing the number of distinct objects by means of the data structure is also referred to as a cardinality estimation.

An alternative data structure is described in document U.S. Pat. No. 8,406,132 B2, particularly in column 5, line 56 to column 6, line 59.

Independent of implementation details of the data structure, the technique disclosed herein allows in the steps 302 and 402 synchronizing a plurality of nodes 502 to 506 that independently count distinct objects in a distributed manner throughout a telecommunications network 500. The data structure reduces the data traffic towards the NMS 508, because the memory required for the data structure is significantly less than the memory required for reporting a detailed list identifying each of the distinct objects.

Furthermore, the data structure is unifiable, which includes the property of merging in step 306 two or more instances of the data structure and/or adding one or more objects to a given instance of the data structure, so that the resulting instance represents the total number of distinct objects. The data structures specified by the configuration parameters in the steps 302 and 402 thus reduces memory requirements at the side of the counting nodes 502 to 506, e.g., by directly adding further objects to the instance of the data structure in the step 404, reduces the traffic load of the network 500 between the nodes 502 to 506 and the NMS 508 according to the steps 304 and 406, and enables the NMS 508 to derive the number of distinct objects at arbitrary levels of aggregation by virtue of the step 306.

For example, the nodes 502 to 506 monitor data traffic in routers of the network 500 and measure the cardinality of destination IP addresses for each host. The cardinality is periodically reported according to the steps 304 and 406 from the nodes to the NMS 508. The NMS 508 detects unusual behaviour, e.g., port scanning in a worm outbreak, by regularly checking the cardinality at a higher level of aggregation based on the step 306 of merging the received data records.

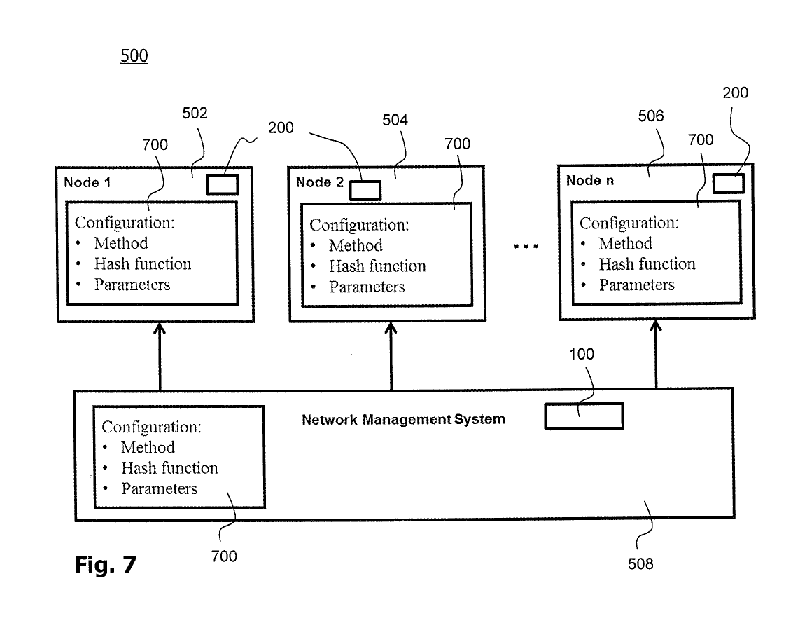

FIG. 7 schematically illustrates the network 500 in a stage of configuration according to the steps 302 and 402. In order to consistently merge the data records originating from different nodes 502 to 506 and to compute the cardinality estimations (e.g., at the NMS 508), the configuration parameters shown at reference signs 700 specify a method implementation, a hash function and parameters of the data structure. The method implementation may specify, e.g., the algorithm of afore-mentioned research publication “Loglog counting of large cardinalities” by M. Durand et al.

The specified hash function may be any surjective mapping, e.g., onto a binary string of length k+K, in such a way that the resulting bits composing the hash value closely resemble random uniform independent bits. The parameters of the data structure may specify the number m=2^{k} of integers in the array (which is also referred to as the number of buckets) and/or the range 0, . . . , K−1 of each of the integers in the array (which is also referred to as the bucket size). The bucket size depends on a maximum cardinality of the total set of objects counted by the nodes as a whole. The number of buckets depends on a target threshold for accuracy. Both, the number of buckets and the bucket size depend on a target threshold for the storage space of the data structure.

For example, if the set of objects to be counted is the set of subscribers distinguished by their subscriber identifiers, the data structure parameters depend on a number of subscribers of the network 500. Due to the advantageous scaling property of the data structure, a large range (including, e.g., 1 million subscribers or over 10 million subscribers) of subscriber population can be counted.

The parameters are determined based on a balance between the size of memory, 2^{k}·log₂ K, of the data structure and the accuracy of the cardinality estimation, which scales proportional to 2^{-k/2}. Since the bucket range, K, scales proportional to the maximum cardinality, Nₘₐₓ, the memory requirement scales as the logarithm of the logarithm of the maximum cardinality, i.e.,

size of data structure ˜log(log(Nₘₐₓ)) for a certain accuracy.

By way of example, for a maximum cardinality (e.g., a total number of subscribers of the network 500) equal to 100 million, the number of distinct objects can be counted (i.e., the cardinality can be estimated) with a standard error of 4% using m=1024 hbuckets of K=5 bits each, that is 640 bytes for the data structure in total. The standard error can be decreased to 2.8% by using m=2048 buckets resulting in 1280 bytes for the data structure in total.

The configuration parameters 700 are distributed according to the steps 302 and 402 of the methods 300 and 400, respectively, by the NMS 508 towards the nodes 502 to 506. The distribution is performed via an existing Operation and Management (O&M) interface. The distribution of the configuration parameters 700 is performed periodically in one implementation of the technique. Another implementation of the technique performs the steps 302 and 402 in response to a request from one or more of the nodes 502 to 506.

While FIG. 7 schematically illustrates a centralized architecture for populating the configuration parameters 700 by the NMS 508, a variant of the network 500 includes two or more devices 100 distributed in the network 500. For example, the distributed devices 100 are sub-nodes of a hierarchy of control nodes for hierarchically distributing the control parameters 700.

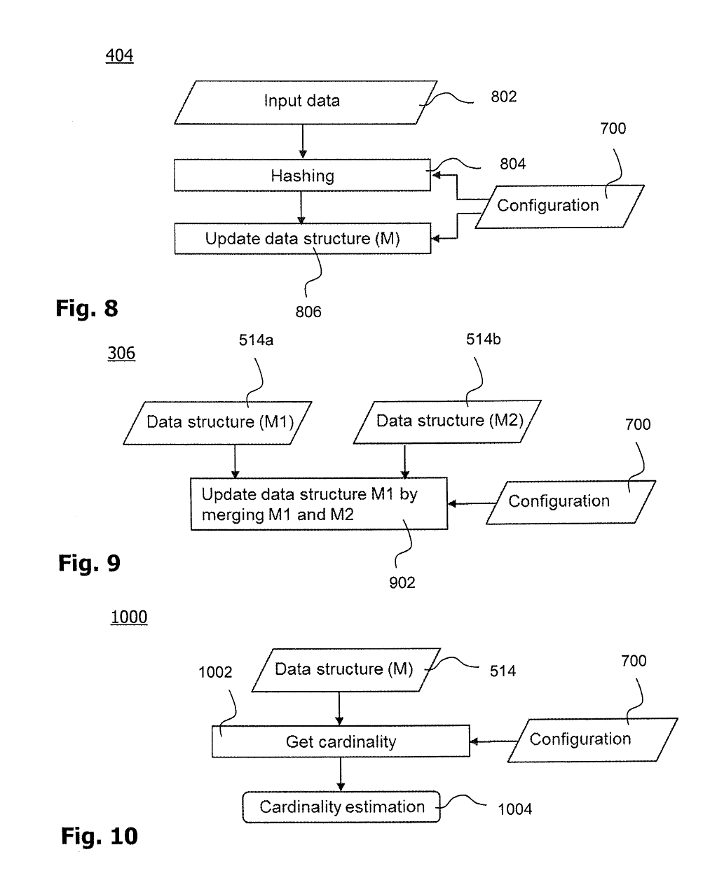

FIGS. 8 to 10 show flow charts of basic operations related to the data structure. The data structure replaces a conventional counter for representing aggregated data. The data structure differs from a conventional counter in its format and in the basic operations for adding (according to the step 404), merging (according to the step 306) and reading the number of distinct objects represented by the data structure. Below table summarizes these differences.

| | Traditional counters | Cardinality estimation |
|---|---|---|
| Format | numeric | bit-string 514 |
| Method to update | increment counter | specific algorithm, step 404 |
| Method to merge | add counter values | specific algorithm, step 306 |
| Method to read | read the number | calculate cardinality, step 1000 |

All three basic operations are performed on the data structure. Therefore, all basic operations have to consistently apply the same configuration parameters specifying the data structure. Since the basic operations are performed throughout the network 500 as a distributed system, the steps 302 and 402 of the method set 300 and 400, respectively, allow consistently performing the basic operations.

According to the steps 304 and 406 of the methods 300 and 400, respectively, the data record 514 representing aggregated data is reported in the telecommunications network 500. The data record 514 represents the number of distinct objects, i.e., the cardinality, of a given object type at a certain level of aggregation. The data record is not just a single number. Rather, the cardinality is represented by a data structure having typically 1 to 2 kilobytes (KB) in size and that is optimized for estimating the cardinality from a large subset of the distinct objects so that further objects can be added according to the step 404 of the method 400 and/or two or more data records can be merged according to the step 306 of the method 300. The merged data record thus represents a further level of aggregation.

The bit-string 514 for the cardinality estimation comprises 2^{k}·log₂ K bits for the data structure, an exemplary instance of which is schematically illustrated in FIG. 6. Moreover, the NMS 508 optionally extends the cardinality estimation (schematically represented by the right column in above table) to includes further identifiers only available in the NMS 508 and not in the nodes 502 to 506. For example, an identifier for the type of objects (data packets, subscribers, etc.) and/or an identifier for a level of aggregation (e.g., cell identifier, cell cluster identifier, etc.) is included.

The relation between a multiset of objects and the data record according to the data structure representing the number of distinct objects in the multiset is described for an exemplary implementation of the data structure. The multiset of objects (which may include redundancies) is denoted by S. Independent of the type of objects, the multiset S can be considered as a data set of binary sequences. Redundancy means that the same binary sequence occurs more than once in S. The aim is to estimate the number of distinct objects (i.e., distinct binary sequences in S).

Denoting the position of the first 1-bit of the binary sequence x by Q(x), it is known from mathematics that the logarithm of the cardinality of S can be roughly estimated by the maximum value of Q (x):

R(S)=max_{x∈S}(p(x)).

The estimation can be improved by separating the objects in S into m groups (which are also referred to as buckets) and performing above estimation for each of the buckets:

Mⱼ=R(Sⱼ).

Herein, Sⱼ for j=1, . . . , m are the separated groups. FIG. 6 illustrates an example for the corresponding data record representing the cardinality of the multiset S.

FIG. 8 shows a flow chart of an exemplary implementation of the step 404 of adding one or more objects to a data record according to the data structure. In one use case, the data record 514 is updated in response to an object 802, e.g., a further measurement result resulting from a periodic measurement or the most recent entry in the event log-files 510.

In another use case, a detailed list of objects, which optionally includes object redundancies (e.g., the log file 510) is the basis for generating a new data record 514. The detailed list is processed, entry by entry, each of the entries forming the input data 802 for the step 404 of adding a further object.

The object to be added is represented by input data 802. The input data 802 is subjected to the hash function specified by the configuration parameters 700 to assure that the buckets (i.e., the positions in the array) associated in each case with objects to be added are evenly distributed among the buckets.

The bit position of the first 1-bit in the K most significant bits of the resulting hash value 804 are compared with the existing integer value in the data record 514 at the position specified by the k least significant bits. If the bit position is greater than the existing integer value, the data record 514 is updated by replacing the integer value at the corresponding position by the bit position in a substep 806. The substep 804 of computing the hash value and the comparison in the substep 806 dependent on details specified by the configuration parameters 700. For example, the configuration parameters 700 can specify whether the first 1-bit or the first 0-bit in the hash value is used in the comparison.

The merging step 306 enables further aggregating the number of distinct objects. FIG. 9 shows a flow chart of an exemplary implementation of the step 306 of merging two data records 514a and 514b. In the substep 902, a merged data record is computed by setting the integer value in the array to the maximum of the integer values at corresponding positions in the array of the data records 514a and 514b to be merged. In the exemplary implementation shown in FIG. 9, the merged data record replaces the existing data record 514a. The configuration parameters 700 also specify the details of the substep 902, e.g., instead of using the maximum in the comparison, the minimum of the comparison can be selected.

While FIG. 9 illustrates merging two data records 514, it is possible to merge more than two data records 514. More than two structures 514 can be merged one after another or by a direct comparison, bucket by bucket, for identifying the maximum integer value among all data records 514 to be merged.

The order of merging more than two data records 514 according to the step 306 and the order of adding more than two objects according to the step 404 has no influence on the resulting data record 514 representing the updated set of distinct objects, since the maximum value is independent of the order of integer values to be compared. Due to the nature of the maximization, no information is lost when the step 306 of merging is performed iteratively instead of the direct comparison.

Moreover, initializing a data record and adding a multiset of objects, one by one, according to the step 404 yields the same data structure resulting from merging two or more data records, if each of which represents a sub-multiset of the multiset objects so that the union of multisets includes all distincₜ objects of the multiset. Therefore, the technique allows robustly counting distinct objects in a distributed manner in the telecommunications network 500.

FIG. 10 shows a flow chart of a step 1000 of computing the number of distinct objects as represented by any given data record 514. The step 1000 can be performed by the device 100 in the context of the method 300, e.g., based on the received data record or the merged data record. The step 1000 can also be performed by the device 200 in the context of the method 400, e.g., based on the data record 514 prior to, and/or resulting from, the step 404.

Based on the data record 514, the number of distinct objects (e.g., in the multiset S) is computed in a substep 1002 according to

$$E = {α}_{m} {m 2}^{\frac{1}{m} {\sum }_{j = 1}^{m} {M}_{j}} .$$

Herein, αₘ is a correction constant depending on m. The computation 1000 is based on the statistical properties of the hash function 804. Therefore, the computed number of distinct objects is an estimate for the cardinality.

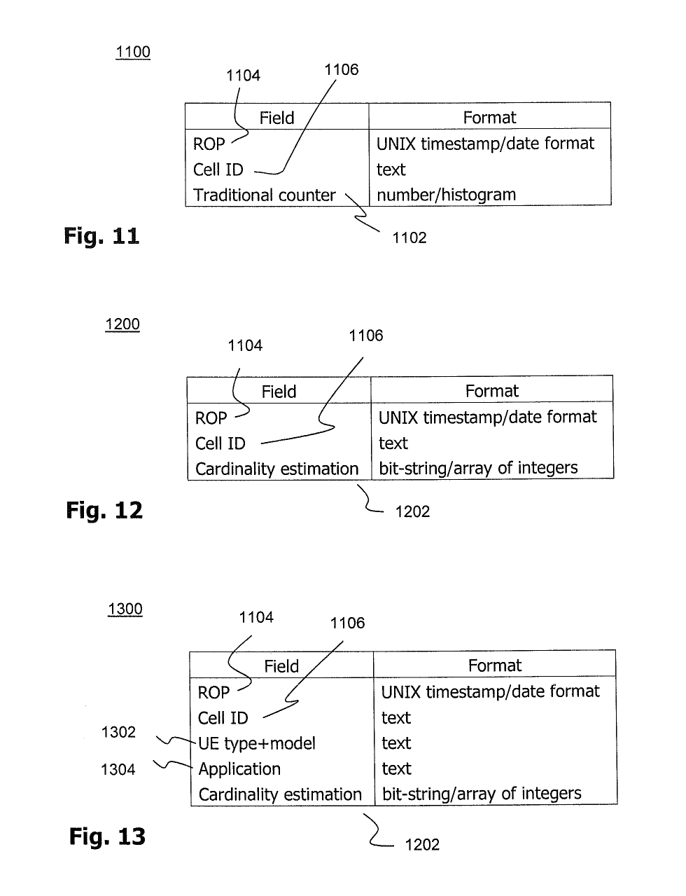

When counting the number of distinct subscribers, a conventional implementation stores (e.g., in the counting nodes or the NMS) a conventional non-unifiable cardinality report schematically illustrated in FIG. 11. The non-unifiable report identifies for the reported traditional counter 1102 of distinct subscribers an associated timeframe 1104 and an associated location area 1106. The traditional counter represents the aggregated dated as a single number or a histogram, in which each entry represents a single number for the corresponding histogram parameter.

FIG. 12 schematically illustrates a unifiable report 1200, wherein the traditional counter 1102 is replaced by the unifiable data structure shown at reference sign 1202. The format and the content of the unifiable data structure 1202 differ from the traditional counter 1102. The unifiable data structure 1202 is not a single number or a histogram of single numbers. The unifiable data structure is an array of integers, wherein each distinct object added to the data records 514 according to the data structure 1202 has a certain probability of replacing one of the integer values in the array of integers so that the data record 514 as an instance of the data structure 1202 is a fingerprint of the subset of distinct objects. The sum of the integers values included in the array is a measure for the number of distinct objects. The aggregated data as represented by the conventional non-unifiable report 1100 is readily computed from the unifiable report 1200 according to the step 1000, so that the unifiable report 1200 implies the information provided by the non-unifiable report 1100. The converse is not true. The unifiable report 1200 can be updated according to the step 404 and further aggregated to higher levels of aggregation according to the step 306.

In an advanced embodiment, the NMS 508 includes in the configuration parameters 700 further criteria for specifying the level of aggregation of a report 1300 reported by the nodes 502 to 506. The more criteria are specified, the lower the level of aggregation of the report 1300. In the advanced embodiment for the report 1300 shown in FIG. 13, in addition to temporal and spatial criteria 1104 and 1106, the configuration parameters specify categories for the UE type and model 1302 and applications 1304 executed by the UE. Solely based on a plurality of reports including one report 1300 for each entry in the specified categories, the NMS 508 can derive the report 1200 (representing a higher level of aggregation) by merging all reports 1300 relating to the same timeframe 1104 and location 1106. In other words, by merging an entire category of reports 1300 according to the step 306, the category can be eliminated.

As has become apparent from above description of exemplary embodiments, the number of distinct objects (i.e., the cardinality) of a large multiset of objects can be observed, counted and stored in a distributed manner in a telecommunications network. For locally counting the objects, new objects can be added. For increasing the level of aggregation, two or more data records according to the data structure can be merged prior to reporting the counted objects to a central network controller or after reporting by the central network controller.

Basic operations for the data structure are efficient and the size of the data structure scale with a total number of distinct objects as the logarithm of the logarithm of the total number. Hardware resources required for the counting are thus reduced at counting nodes compared to conventional techniques that have to maintain and process detailed lists of distinct objects.

Furthermore, the network load for reporting the counting results is reduced due to the efficient data structure, by avoiding reports including the detailed lists of distinct objects and/or by avoiding multiple reports relating to different levels of aggregation, since the reports can be further aggregated at the central network controller.

The central network controller is provided with relevant statistical information at a predefined level of aggregation in time and space that can be further aggregated to larger special regions or longer time frames.

In the foregoing, various exemplary modes of implementing the technique disclosed herein have been described. However, the present invention should not be construed as being limited to the particular principles or modes discussed above. Rather, it will be appreciated that variations and modifications can be made by a person skilled in the art without departing from the scope of the present invention as defined in the following claims.

1-24. (canceled)

25. A method of counting distinct objects in a telecommunications network including a plurality of nodes, each of the plurality of nodes counting a subset of the distinct objects, the method comprising:
sending configuration parameters to the plurality of nodes, wherein the configuration parameters specify a data structure for representing a number of the distinct objects, wherein the data structure includes an array of integers for representing the number of the distinct objects;
receiving two or more data records according to the data structure from at least one of the plurality of nodes, each of the two or more received data records representing a number of the distinct objects counted by the corresponding one of the plurality of nodes; and
merging the two or more received data records in a merged data record according to the data structure, by comparing corresponding integers in the two or more received data records, wherein the merged data record represents the number of distinct objects underlying at least one of the two or more received data records.

26. The method of claim 25, further comprising computing the number of distinct objects underlying at least one of the two or more received data records from at least one of the two or more received data records and the merged data record.

27. The method of claim 26, wherein the number of distinct objects underlying at least one of the two or more received data records is computed according to
$$E = {α}_{m} {m 2}^{\frac{1}{m} {\sum }_{j = 1}^{m} {M}_{j}} ,$$
wherein Mⱼ is the j-th integer in the array including m integers.

28. The method of claim 25, further comprising adding an object to one of the two or more received data records according to the data structure by determining an integer in the array of integers for the object and comparing the determined integer with a corresponding integer in the data record.

29. The method of claim 28, wherein the determined integer depends on a hash value of the object.

30. The method of claim 29, wherein the configuration parameters specify a hash function for computing the hash value.

31. The method of claim 29, wherein the determined integer is associated with a position in the array including m=2^{k} integers according to the k least significant bits of the hash value of the object.

32. The method of claim 29, wherein the determined integer is the position of the least significant 1-bit that follows the k least significant bits in the hash value of the object.

33. The method of claim 25, wherein the configuration parameters specify a range of the integers.

34. The method of claim 25, wherein the configuration parameters specify a number, m, of the integers included in the array.

35. The method of claim 25, wherein the comparison in at least one of the step of merging and the step of adding includes determining a maximum and replacing the corresponding integer by the determined maximum.

36. The method of claim 25, wherein each of the two or more received data records represents a number of distinct objects for a predefined timeframe and/or in relation to the corresponding one of the plurality of nodes.

37. The method of claim 25, wherein the distinct objects include at least one of distinct network events, distinct subscriber wired or wirelessly connected to the corresponding one of the plurality of nodes, and data packets having distinct combinations of source and destination.

38. The method of claim 25, wherein the configuration parameters specify a reporting period and/or a measurement period, and wherein the two or more data records are periodically received.

39. The method of claim 25, wherein the configuration parameters specify categories for distinguishing the distinct objects.

40. A method of counting distinct objects in a telecommunications network including a plurality of nodes, each of the plurality of nodes counting a subset of the distinct objects, the method comprising:
receiving configuration parameters from a network controller, wherein the configuration parameters specify a data structure for representing a number of the distinct objects, wherein the data structure includes an array of integers for representing the number of the distinct objects;
adding one or more objects to a data record according to the data structure by determining, for each object to be added, an integer in the array of integers and comparing the determined integer with a corresponding integer in the data record; and
sending the data record according to the data structure to the network controller.

41. The method of claim 40, further comprising maintaining a list of objects, wherein the step of adding includes initializing the data record according to the data structure and adding each of the objects in the list to the data record.

42. The method of claim 41, wherein the list is deleted upon completion of the step of adding for each object in the list.

43. The method of claim 40, wherein the integer is determined based on a hash value of the object to be added, and wherein the configuration parameters specify a hash function for computing the hash value.

44. The method of claim 40, wherein the data record is at least one of initialized and sent according to a measurement period, and wherein the configuration parameters specify the measurement period.

45. A non-transitory computer-readable storage medium storing a computer program comprising program code portions that, when executed on at least one processor of one or more computing devices, cause the one or more computing devices to:
send configuration parameters to a plurality of nodes, wherein the configuration parameters specify a data structure for representing a number of distinct objects, wherein the data structure includes an array of integers for representing the number of the distinct objects;
receive two or more data records according to the data structure from at least one of the plurality of nodes, each of the two or more received data records representing a number of distinct objects counted by a corresponding one of the plurality of nodes; and
merge the two or more received data records in a merged data record according to the data structure by comparing corresponding integers in the two or more received data records, wherein the merged data record represents a number of distinct objects underlying at least one of the two or more received data records.

46. A non-transitory computer-readable storage medium storing a computer program comprising program code portions that, when executed on at least one processor of one or more computing devices, cause the one or more computing devices to:
receive configuration parameters from a network controller, wherein the configuration parameters specify a data structure for representing a number of distinct objects, wherein the data structure includes an array of integers for representing the number of the distinct objects;
adding one or more objects to a data record according to the data structure by determining, for each object to be added, an integer in the array of integers and comparing the determined integer with a corresponding integer in the data record; and
sending the data record according to the data structure to the network controller.

47. A device for counting distinct objects in a telecommunications network including a plurality of nodes, each of the nodes counting a subset of the distinct objects, the device comprising:
a transceiving circuit configured to:
send configuration parameters to the plurality of nodes, wherein the configuration parameters specify a data structure for representing a number of the distinct objects, wherein the data structure includes an array of integers for representing the number of the distinct objects; and
receive two or more data records according to the data structure from at least one of the plurality of nodes, each of the two or more received data records representing a number of distinct objects counted by a corresponding one of the plurality of nodes; and
a processing circuit configured to merge the two or more received data records in a merged data record according to the data structure by comparing corresponding integers in the two or more received data records, wherein the merged data record represents a number of distinct objects underlying at least one of the two or more received data records.

48. A device for counting distinct objects in a telecommunications network including a plurality of nodes, each of the nodes counting a subset of the distinct objects, the device comprising:
a transceiving circuit configured to receive configuration parameters from a network controller, wherein the configuration parameters specify a data structure for representing a number of the distinct objects, wherein the data structure includes an array of integers for representing the number of the distinct objects; and
a processing circuit configured to add one or more objects to a data record according to the data structure by determining for each object to be added an integer in the array of integers and comparing the determined integer with a corresponding integer in the data record,
wherein the transceiving circuit is configured to send the data record according to the data structure to the network controller.
